(19) United States
(12) Patent Application Publication
(10) Pub. No.: US 2013/0229272 A1
(43) Pub. Date: Sep. 5, 2013

(54) Manual control device and method

(71) Applicant: Christopher M. Elliott, Apex, NC (US)

(72) Inventor: Christopher M. Elliott, Apex, NC (US)

(73) Assignee: CATERPILLAR INC., Peoria, IL (US)

(21) Appl. No.: 13/412,354

(22) Filed: Mar. 5, 2012

(51) Int. Cl. G08B 6/00; G05G 9/047

(52) U.S. Cl. 340/407.2; 74/471 XY

(57) ABSTRACT

A manual control device for a machine includes a handle having a variable damper configured to alter a stiffness thereof in response to a control signal. A displacement sensor provides a displacement signal indicative of the displacement of the handle. A controller is associated with the variable damper, the manual control device, the displacement sensor, and the actuator. The controller determines a then present operating state of the actuator and a command provided to the actuator based on the displacement signal, and provides the control signal to stiffen the variable damper such that the displacement of the handle is limited to an additional displacement of the handle that corresponds to a difference between the then present operating state of the actuator and a maximum allowable operating state of the actuator.

### TECHNICAL FIELD

This patent disclosure generally relates to manual control devices and, more particularly, to manual control devices providing haptic information to a user.

### BACKGROUND

Machines having implements are typically controlled by a combination of control devices. For example, an operator may use one device to move the machine into a desired direction, for example, a steering wheel or yolk, a different device to accelerate and decelerate the machine, for example pedals or levers, and yet a different device, for example, a joystick, to operate an implement of the machine, such as a bucket or shovel.

When machines such as excavators are operating, they are often operating in confined areas and can be surrounded by either immovable objects, such as building structures, or hazardous conditions, such as power lines. In those conditions, it is desired to maintain accurate and precise control of the motion of the work implement to ensure safe machine operation. Currently, machines such as excavators, cranes and the like, use joystick-type control devices to control motion of their implements. These joysticks can have two, three or more degrees of freedom of motion, each of which corresponds to a particular direction or type of motion of the work implement. When an operator is manipulating the control, the operator can simply move the control in various fashions to achieve the desired placement and trajectory of the work implement.

When operating such machinery, it is advisable to carefully control the position and motion of the work implement such that overshoot in the position of the work implement is avoided. Until now, the careful positioning of the work implement is determined by the experience and perception of the operator. However, inexperienced or inattentive operators may, at times, overshoot the position of the implement or overcompensate the force required to move the implement when an obstruction is present, and as a result place the implement in an undesired location. These situations cannot be avoided at present.

### SUMMARY

A machine includes an actuator operating to displace an implement based on a command provided by an operator. The command is provided in the form of a displacement of a handle of a manual control device by the operator. The displacement of the handle occurs in an activation direction of the handle. The machine includes a variable damper associated and displaceable with the handle. The variable damper is configured to selectively alter a stiffness thereof in response to a control signal. A displacement sensor is associated with the variable damper and configured to provide a displacement signal indicative of the displacement of the handle. A controller is associated with the variable damper, the manual control device, the displacement sensor and the actuator. The controller is disposed to determine a then present operating state of the actuator, determine a command provided to the actuator based on the displacement signal, and provide the control signal to stiffen the variable damper such that the displacement of the handle is limited to an additional displacement of the handle that corresponds to a difference between the then present operating state of the actuator and a maximum allowable operating state of the actuator.

In another aspect, the disclosure describes a method for providing haptic information to an operator of a manual control device for a system. The manual control device may include a handle adapted for use by the operator to issue commands, which are provided in the form of a displacement of the handle in an activation direction where the extent of displacement is indicative of a magnitude of each command. The method includes selectively altering a stiffness of a variable damper associated with the handle, determining a then present command based on the displacement of the handle, determining a maximum possible command that is allowable based on a capability of the system, and limiting the displacement of the handle to an additional displacement of the handle by stiffening the variable damper when the then present command approaches the maximum possible command. In one embodiment, the additional displacement of the handle corresponds to a difference between the then present command and the maximum possible command.

In yet another aspect, the disclosure describes a positive-force generating device mounted via at least one variable damper to a machine. The variable damper is configured to selectively alter a stiffness thereof in response to a control signal. The device is moveable in a direction of application of an impulse force by compression or extension of the variable damper. The positive-force generating device includes a displacement sensor associated with the variable damper and configured to provide a displacement signal indicative of a displacement of the device. A controller is associated with the variable damper, the device, and the displacement sensor. The controller selectively provides the control signal to alter the stiffness of the variable damper. A motor is responsive to a command signal from the controller has a mass connected to an output shaft of the motor. The mass has a center of gravity that is offset relative to an axis of rotation of the output shaft of the motor. An encoder is configured to provide a rotational signal to the controller that is indicative of a rotational position of the mass relative to the device. The controller is configured to provide the command signal to the motor and the control signal to the variable damper based on the rotational signal and the displacement signal such that the impulse force is selectively provided along a predetermined direction.

### BRIEF DESCRIPTION OF THE DRAWINGS

FIGS. 1-3 are various views of a machine in accordance with the disclosure.

FIG. 4 is a block diagram of an implement control system for a machine in accordance with the disclosure.

FIG. 5 is a block diagram of a control in accordance with the disclosure.

FIG. 6 is a time chart of various signals to illustrate control principles for the directional application of force in accordance with the disclosure.

FIG. 7 is a block diagram for a force-feedback control in accordance with the disclosure.

### DETAILED DESCRIPTION

This disclosure describes an exemplary embodiment relative to a machine having a work implement. Operation of the work implement can be carried out by the selective control of actuators, which are responsive to control signals from a machine controller. In one embodiment, a manual control device is configured to control the actuators in response to user input through appropriate displacement of a control handle. The control handle is configured to provide haptic feedback to the user or operator that is indicative of the loading condition or operating condition of the implement actuators. The haptic feedback may be embodied in the form of a selectively variable resistance to handle displacement such that the issuance of commands that exceed the then present power capabilities are avoided. The haptic feedback can also include a positive force feedback tending to push the handle when the handle is indicating a command to the actuators that exceeds the then present capabilities of the system. Although the described embodiments relate to control of a machine implement, the structures and methods relating to the manual control device have universal applicability to applications involving human-machine interfaces and controls.

As used herein, the term “machine” may refer to any machine that performs some type of operation associated with an industry such as mining, construction, farming, transportation, marine or any other industry known in the art. For example, although an excavator is shown in certain figures, the machine may generally be an earth-moving machine, such as a wheel loader, excavator, dump truck, backhoe, motor grader, or may alternatively be any other type of machine, such as a material handler, a locomotive, paving machine or the like. Similarly, although an exemplary bucket is illustrated as the attached implement of the illustrated excavator, any implements may be utilized and employed for a variety of tasks, including, for example, loading, compacting, lifting, brushing, and include, for example, buckets, compactors, forked lifting devices, brushes, grapples, cutters, shears, blades, breakers/hammers, augers, and others.

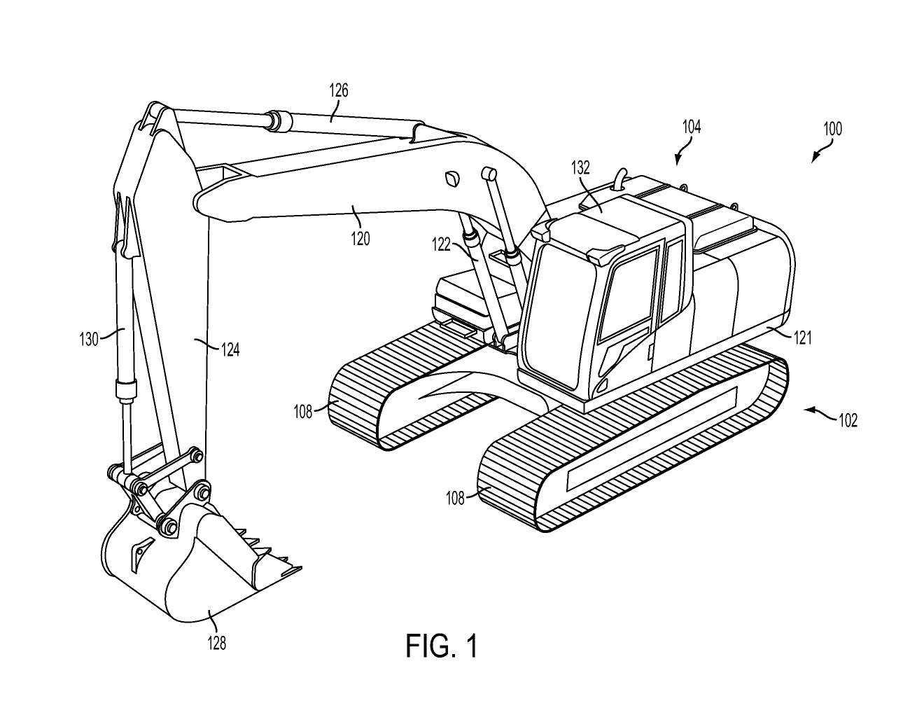

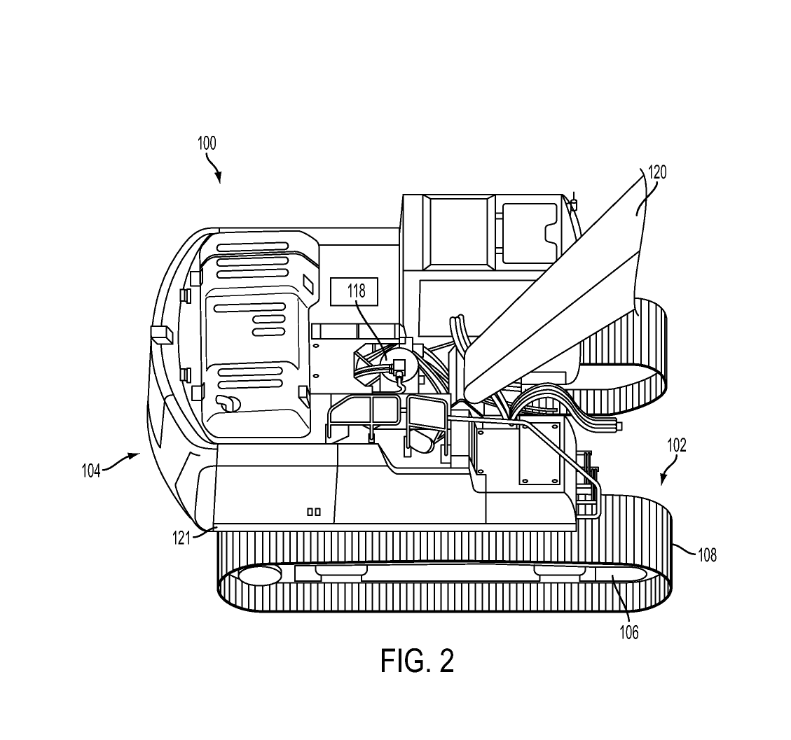

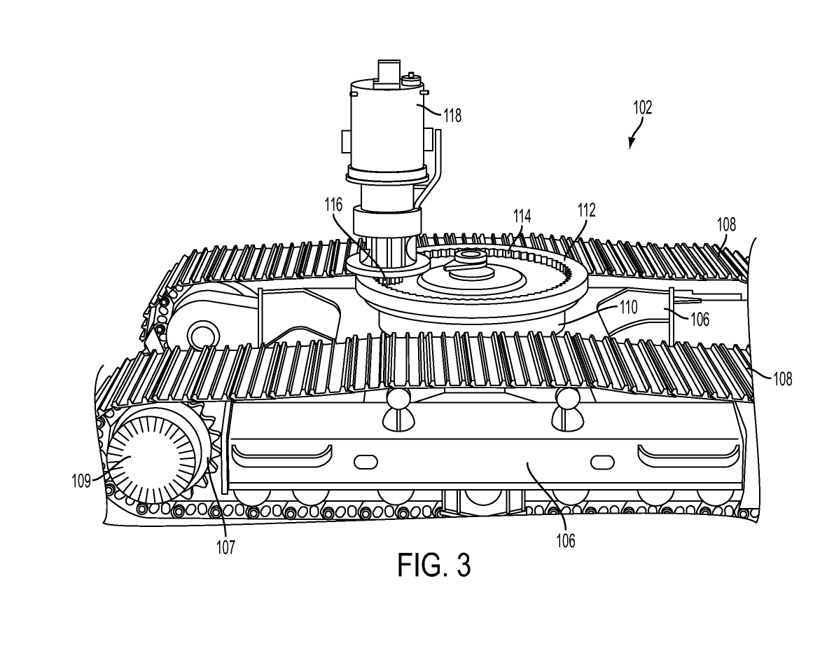

With the foregoing in mind, an excavator 100 is shown for purpose of illustration in FIG. 1. The excavator 100 includes an undercarriage 102 and an upper structure 104. The undercarriage 102, which is also shown in FIG. 3, includes a generally H-shaped frame 106 that supports two crawler tracks 108 along its edges and includes a post 110 supporting a ring gear 112 close to its center. The crawler tracks 108 are moved by sprockets 107 that are rotated by hydraulic drive motors or electric drive motors 109 connected to the frame 106. The ring gear 112 includes a plurality of teeth 114 arranged along its inner periphery, which mesh with a drive sprocket 116 powered by a swing motor 118. In reference to FIG. 2, the swing motor 118 is connected to the upper structure 104 such that rotation of the drive sprocket 116 causes the relative rotation of the upper structure 104 relative to the undercarriage 102.

In reference now to FIGS. 1 and 2, the upper structure 104 includes a boom 120 that is pivotally connected to an upper structure frame 121 and pivoted by use of two boom actuators 122. An arm 124, which is also commonly referred to as a stick, is pivotally connected at an end of the boom 120 and pivoted by an arm actuator 126. A bucket 128 is connected at an end of the arm 124 and pivoted by a bucket actuator 130. The boom actuators 122, the arm actuator 126 and the bucket actuator 130 are embodied in the illustrations as linear hydraulic cylinders, which are configured to be extended and retracted by selective porting of pressurized fluid on one side of a hydraulic piston. The various functions of the machine 100 may be controlled in part by the appropriate handling of various control devices by an operator occupying a cab 132. The swing motor 118 may be powered by hydraulic or electrical power.

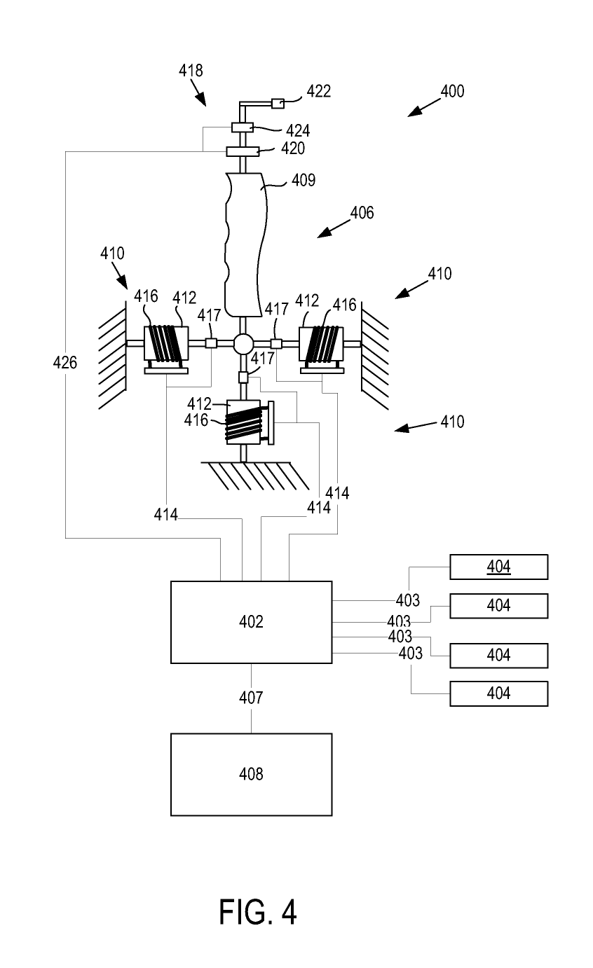

A block diagram for an implement control system 400 for the machine 100 is shown in FIG. 4. The word “implement” is used herein to generally refer to any device on the machine 100 that is moved by an actuator. In the illustrated embodiment, the implement is considered to be the bucket 128 and the various actuators providing four degrees of freedom of motion of the bucket 128, that is, the swing motor 118 that operates to rotate the boom 120 and arm 124 together with the bucket 128 relative to the undercarriage 102, the boom actuators 122, which operate to lift and lower the boom 120, the arm actuator 126, which pivots the arm relative to the boom, and the bucket actuator 130, which tilts the bucket 128 relative to the arm 124. As can be appreciated, operation of each of the swing motor 118, boom actuators 122, arm actuator 126, and bucket actuator 130, will independently cause a rotational or arcuate motion of the bucket 128 in one of four different trajectories in a three-dimensional space.

In reference to the implement control system 400, a command provided to each of the afore-mentioned actuators causing displacement of the implement originates at a controller 402. The actuators 404 controlling position and motion of a machine implement are generically represented in FIG. 4. The controller 402 may be an electronic controller configured to provide appropriate signals to components or systems of the machine 100 that operate to effect activation of each actuator 404. The command signals provided by the controller 402 are based on command signals provided by a manual control device 406. Information may be provided to the actuators through dedicated actuator communication lines 403, which communicate with other actuator activation devices, such as electromechanical hydraulic-fluid valves and the like. The manual control device 406 may be one of a plurality of operator-controlled devices used to control operation of the machine 100. Although one device 406 is illustrated, other control devices may also be connected to the controller 402 but are not shown in the illustration of FIG. 4 for simplicity.

The controller 402 is further in communication with other machine systems 408 via a communication line 407. The other machine sensors and systems 408 are generically shown collectively as a single block in FIG. 4 and may include the engine or other prime movers of the machine, fluid pumps, transmissions, and others. Such devices or systems of the machine may provide feedback information to the controller 402 that is indicative of the operating state of each system or components and, in certain embodiments, may include information about the extent of power-output saturation of these systems. Power output saturation in this context is meant to describe the portion of available power output of each device relative to the total power output capability of that device.

Accordingly, the feedback information may include signals indicative of the duty cycles of those systems, the degree of power output of those systems as a percentage of the power input to those systems, and any other information that provides the controller 402 an indication of the rate and magnitude of power output is in a condition to provide in the event a maximum command is provided by the manual control device 406. For example, when lifting a heavy load in the bucket 128 that approximates the lifting capacity of the boom actuators 122, the corresponding sub-system that monitors and controls operation of those actuators may provide an indication to the controller 402 that one or more of the boom actuators 122 is/are near their output force capacity and have limited responsiveness to additional lifting force commands. Similar indications may be provided for each of the other actuators 404 of the machine that participate in moving the work implement of the machine or in conducting other machine functions. This and other information from the actuators 404 and machine systems 408 is provided to the controller 402 via the actuator communication lines 403 and/or the communication line 407.

In the illustrated embodiment, the manual control device is a joystick-type control device having a handle 409 connected to three haptic control and feedback assemblies 410. Each assembly 410 includes a damper device 412 having a stiffness and/or range of motion that is adjustable in response to a control signal provided by the controller 402 via a dedicated control line 414. In the illustrated embodiment, each damper device 412 is a magnetorheological (MR) fluid-based force feedback damper. Dampers employing MR fluid-based properties may typically include MR fluids that are controlled by a magnetic field, which is typically induced by an electromagnet 416. In this way, the damping characteristics of an MR damper can be finely controlled by appropriately controlling the intensity and other characteristics of the magnetic field. For example, the viscosity of the MR fluid in the damper can be controlled by controlling the current provided to the electromagnet. In alternative embodiments, each damper device may be a hydraulic piston arrangement in which a single piston or two opposing pistons is/are displaced when fluid passes into and out from piston volumes. The flow of fluid into and out from the piston volume may be controlled by an electromechanical valve operating to selectively modulate fluid flowing therethrough in response to the control signal provided by the controller. In this way, the stiffness of each damper device may be infinitely controlled through the control of the electromechanical valve. In the present disclosure, dampers having a variable stiffness capability may be generally referred to as variable dampers, which is a term contemplated to encompass any type of damper arrangement that has a variable stiffness capability, including MR fluid-based or hydraulic dampers having valves to modulate fluid flow therethrough as described.

Returning now to the illustrated embodiment, various types of MR fluid-based dampers are suitable for use with the damper devices 412. One example of an MR fluid-based damper suitable for use in vehicle suspension systems can be found in U.S. Pat. No. 7,234,575. Another example of a MR fluid-based damper can be found in U.S. Pat. No. 7,775,333. Both these exemplary descriptions are incorporated herein in their entirety by reference.

In one embodiment of the present disclosure, a damper may include two chambers connected through a flow passage having a predetermined flow orifice therebetween. The area of the flow orifice may be within the effective range of an electromagnet 416. Plungers configured to change the volume of the chambers when moved may be used to push fluid through the orifice when the damper undergoes compressive or tensile axial forces. The viscosity of the MR fluid passing through the orifice, which depends on the intensity of the field created when current passes through the electromagnet, will determine the force required to displace the damper. In alternative embodiments, other MR fluid-based damper arrangements may be used. For example, the MR fluid may be subject to a shearing stress when placed between concentric cylinders, or may be captured within a sponge that is disposed between two moveable walls. In either case, the force required to move the shearing bodies or walls will depend on the intensity of a magnetic field acting on a portion of the fluid. In yet another embodiment, a piston containing a magnet may be disposed inline with an electromagnet within a cylinder such that the force required to move the piston depends on the magnetic field and polarity of the electromagnet.

In the embodiment illustrated in FIG. 4, each of the damper devices 412 is configured to be axially compressed or extended by motion of the handle 409. Magnets 416 associated with each device 412 are responsive to the signals from the controller 402 provided through lines 414 to change the force required to displace each damper 412, and can even operate to selectively seize motion of each device 412 when desired. Each device 412 further includes a position sensor or encoder 417, which is configured to provide a feedback signal indicative of the displacement state and displacement speed of each device 412 to the electronic controller 402, for example, via the communication lines 414. The extent and displacement of the devices 412 is indicative of the extent and speed of displacement of the handle 409, which is taken as an indication of the extent and speed of implement actuation by the operator.

In the illustrated embodiments, the manual control device 406 further includes an optional buzzer or rotating mass assembly 418. The assembly 418 includes a motor 420 having an eccentric weight 422 connected to an output shaft thereof such that a vibration is induced when the motor 420 is operating. The frequency of the vibration depends on the speed of the motor 420, and the amplitude depends on the mass of the weight 422 and/or adjustability of the rotational moment of inertia of the weight 422. A shaft encoder 424 may provide information indicative of the rotational position of the eccentric weight 422 relative to a reference orientation. Control of operation and speed of the motor 420, as well as information from the shaft encoder 424, may be exchanged between those devices and the electronic controller 402 through a buzzer communication and command line 426. The buzzer 418, however, is optional and may be omitted. For example, certain machine applications may inherently possess a predetermined or random vibration profile that is perceptible in the operator cab and, specifically, in the handle 409 of the manual control device. Such inherent vibrations may be the result of engine vibration of the machine, travel of the machine over uneven terrain, vibration of a work implement that is transferred to the cab, and other vibration sources. Examples of work implements that can induce a vibration include vibrators used on vibratory soil or asphalt compactor machines, pneumatic hammers, augers, and the like.

Alternatively, the buzzer may be embodied as a different structure that is configured to induce a vibration along one or more directions. As an illustrative example, the buzzer may include a generally elongate hollow shell having a ferrous or permanent magnet slug slidably disposed therewithin. Electromagnets disposed at each end of the shell such that alternating magnetic fields produced by the magnets can produce a reciprocal motion of the slug within the shell. In this example, a vibration induced by the buzzer would be generally axial along the reciprocal path of the slug. In one embodiment, such an axial vibration could be coupled in a collinear or other fashion, for example, in series with the variable damper, instead of being applied directly to the handle. As can be appreciated, when a vibratory device is coupled to a specific damper, multiple such vibratory devices may be used, each corresponding to a particular variable damper for applications having more than one variable damper.

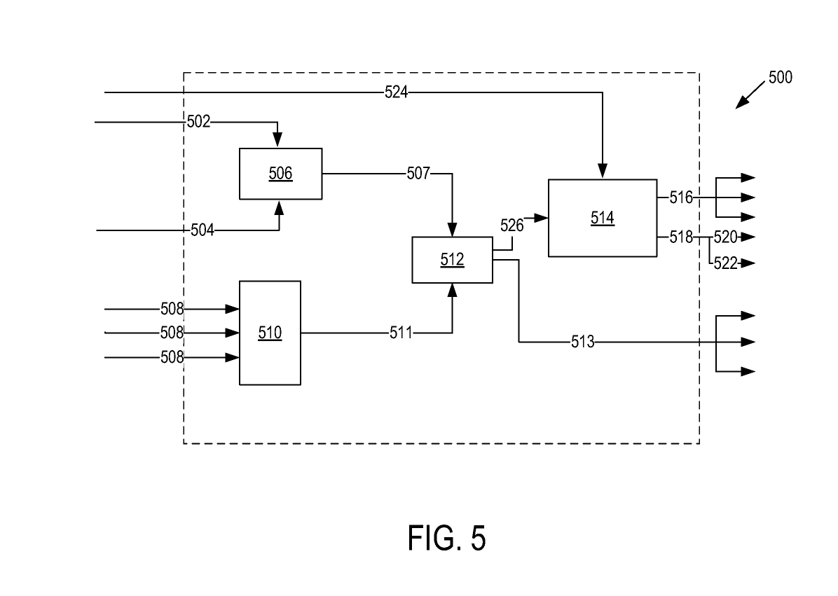

A block diagram for a manual control 500 having haptic feedback capability is shown in the block diagram of FIG. 5. The control 500 may be a control algorithm embodied electronically or mechanically within the controller 402 (FIG. 4) or a mechanical control arrangement. In the illustrated embodiment, the control 500 is embodied as a set of computer executable instructions stored in a tangible, non-volatile electronic storage medium of the controller 402. A processor (not shown) of the controller 402 is configured to access the instructions and provide appropriate commands to other components and subsystems of the controller 402 that are arranged to transmute digital computer commands and signals to and from analog or other commands sent and received from machine systems and actuators.

As shown in FIG. 5, the control 500 is disposed to receive inputs indicative of the operating state of the machine. More specifically, a work signal 502 may be indicative of the operating state of an implement actuator. For example, the work signal 502 may be indicative of the loading of a particular actuator participating in the operation of an implement of the machine 100. However, more than one actuator may participate in the motion of an implement. For example, the lifting and simultaneous scooping and tilting of the bucket 128 (FIG. 1) will require simultaneous participation by the boom, arm and bucket actuators 122, 126 and 130 respectively. The work signal 502 may be indicative of the loading of either of these actuators, or may alternatively be indicative of the loading of a fluid pump (not shown) that provides hydraulic fluid to these actuators collectively. It should be appreciated that in the case of electrical, pneumatic or other types of actuators, the signal 502 may be indicative of the loading of those systems or of the device providing power to those systems irrespective of the type of energy used. In the case of an electric system, for example, the work signal 502 may be a voltage and/or current value present in a bus bar, alternator, storage array and/or the like, while in the case of pneumatic power the work signal 502 may be a pressure and/or flow rate of air provided by a compressor.

The control 500 further receives a limit signal 504. The limit signal 504 is optional and is determined elsewhere in the controller 402 (FIG. 4) (not shown) to be indicative of the power output saturation state of one or more actuators of the machine 100. For example, in the case of a hydraulic piston actuator, the rate at which the hydraulic piston can extend may be limited by the rate at which the corresponding hydraulic pump can provide fluid to the actuator. Thus, even if the actuator has not reached its full motion, the rate at which it can extend may be limited. Alternatively, output saturation may be indicative of the force of the actuator. Using the hydraulic actuator again as an example, the force applied by the actuator may be limited by the maximum output pressure of the hydraulic pump. In the case of electrical actuators, power output saturation may similarly depend on the maximum output current and/or voltage of an electrical power source. These types of limitation may be monitored in the controller 402 to provide a limit signal 504, which may be expressed as a percentage of the total possible actuator force or actuation rate at which the particular actuator is operating at any one time.

The work and limit signals 502 and 504 are provided to a monitor 506, which outputs an inhibition signal 507. The inhibition signal 507, which may be expressed as a ratio between zero and one, is representative of the real-time operating state of an actuator and indicative of the capability of an actuator to respond to any command given by the machine operator, where zero indicates that the actuator is already at its saturation point and one indicates that the actuator is ready to receive and respond to a maximum command. The determination of the inhibition signal 507 may depend on various parameters in addition to the work and limit signals 502 and 504 such as the time-constant for a step response in the actuator, ambient temperature, machine age and various other parameters that may directly or indirectly affect the ability of an actuator to respond to commands.

Moreover, when more than one actuator are monitored at one time, the monitor 506 may be configured to receive numerous work and limit signals 502 and 504, each corresponding to a particular actuator belonging to a group. In this case, the monitor 506 may output numerous inhibition signals 507 corresponding to each actuator or, alternatively, may select the lowest signal to be the inhibition signal 507 provided. Selection of the lowest signal may advantageously be implemented in machines where groups of actuators are operating in a predetermined and coordinated fashion to perform a single operation.

The control 500 may further include displacement signals 508 provided by each of the encoders associated with a manual control, for example, the encoders 417 (FIG. 4). The displacement signals 508 may be collectively processed in a command processor 510 to provide a command signal 511. The command signal 511 is indicative of the type and direction of motion of one or more actuators that is commanded by the machine operator by displacement of a control device in three or more dimensions, for example, by moving and/or twisting the handle 409 (FIG. 4). In an alternative embodiment, the displacement signals 508 may be further processed to determine the nature, frequency and amplitude of a natural or induced machine vibration that is transferred to the handle 409. In such embodiments, for example, a function such as a fast Fourier transform (FFT) may be used to calculate or otherwise determine the frequency of the natural vibration, and limit switches may be implemented to determine vibration amplitude in real time. This information can be used to control and limit the vibration of the handle if desired, and may further be exploited to induce a positive force feedback to the handle as will be described below.

Returning now to FIG. 5, the inhibition and command signals 507 and 511 are provided to a determinator function 512. The determinator function is configured to compare on multiple dimensions the inhibition and command signals 507 and 511 to determine, in real time, whether the actuator(s) participating in a function are in a condition to respond to the operator command or whether, because of certain functional limitations, the operator command exceeds the capabilities of the machine. For example, when swinging the upper structure 104 in one direction at high speed and a change in swinging direction also at a high speed is desired, the machine operator may be tempted to swiftly swing the handle 409 from an extreme position to one side of a control to another side of the control. Physically, the machine may expend energy to slow the rotating structure before initiating motion in the opposite direction. Unless the operator is able to manage the force applied by the machine to accomplish this change in motion orientation, the operator may achieve the swing slower or faster than the machine is capable of achieving the change, in this way undershooting or overshooting the desired motion in the opposite direction. Whether undershooting or overshooting occurs will depend on the experience of the operator and, as a result, there may be loss in machine operating effectiveness and/or efficiency.

In the illustrated embodiment, however, such undershooting or overshooting of the machine, as well as potentially overloading of machine systems, may be avoided by the comparison between the inhibition and command signals 507 and 511 in the determinator function 512. Specifically, the determinator function 512 may determine the readiness of each actuator to receive a different command based on that actuator's inhibition signal 507, examine the command actually provided by the operator based on the command signal 511, and determine whether the commanded motion by the operator is within the then present operational capability of the actuator(s).

When the determinator function 512 concludes, based on this comparison, that the operator command is within the capability of the system, the command signal is permitted to pass through to the actuators and no action is taken in this regard. However, when the determinator function 512 concludes that the command signal, if permitted to pass through to the actuators, would exceed the capabilities of the system, the determinator function 512 outputs a dampening signal 513. The dampening signal 513 is tailored for the particular direction of motion of the handle 409 (FIG. 4) that would yield a command to the actuator requiring a delimiting of the command provided to it. The dampening signal 513 may increase in value the closer an actuator is to a power output saturation point.

In one embodiment, the dampening signal 513 is proportional to the command sent to an electromagnet that is part of a MR fluid-based damper, for example, one of the devices 412 (FIG. 4). In general, the dampening signal 513 is appropriate to appropriately adjust the stiffness of a variable damper such that motion of the handle 409, as representative of the command provided to an actuator, is maintained within acceptable actuator operation limits. In such an embodiment, an increase of the dampening signal 513 would be perceived by the operator as a stiffening of the motion of the manual control device in the direction of increasing commands to the actuator. This stiffening would be interpreted by the operator as a haptic feedback indicative of a saturation in the power output condition of an actuator the operator is attempting to command such that the operator would be aware that operation of the machine is approaching its limits. Moreover, as a practical matter, stiffening of the control in that direction would also avoid or at least minimize the issuance of operator commands that would overload the system.

Nevertheless, it is possible that through the action of multiple actuators at the same time, a command that would overload the system may be present. For such conditions, the present embodiment provides a positive force-feedback function to the manual control device that would effectively not only stiffen motion of the control device towards an overloading command direction, but would also provide a force tending to move the control device away from the overloading command direction. In the illustrated embodiments, the ability to provide a force counter-acting the force of the operator applied to a manual control device in a direction tending to overload the system is provided by appropriate manipulation of a vibration present in the handle 409, which can be provided naturally during machine operation, as previously described, and/or be induced artificially through a vibration device associated with the handle 409, for example, the rotating mass assembly 418 as shown in FIG. 4.

More particularly, the determinator function 512 is configured to provide a force-feedback signal 526 when it is determined that the manual control device has already reached a position that would result in overloading of an actuator. The force feedback signal 526 is provided to a force feedback function 514, which is also configured to further receive an eccentric mass orientation signal 524, for example, provided by the encoder 424. The eccentric mass orientation signal 524 is optional and may be replaced by a calculated natural vibration signal, as previously described. The force feedback function 514 is configured to coordinate the control of the one or more damper devices 412 with the natural vibration or, when present, with the rotating mass assembly 418 such that a net force is applied to the handle 409 (FIG. 4) that tends to push the handle in a particular direction away from a direction in which an overloading command to an actuator is represented. Accordingly, the force feedback function 514 outputs signals 516 to each of the dampers in the system, for example, the damper devices 412. When applicable, the function 514 also outputs an eccentric mass control signal 518, which includes a motor signal 520 configured to command a particular rate of rotation of the eccentric mass that is coupled with an optional control signal 522 configured to set an appropriate moment of inertia to the rotating mass. The control signal 522 is optional and can be used in embodiments where the capability of setting amplitude of vibration is provided, for example, by setting the rotational radius of the rotating mass by a screw drive or other device.

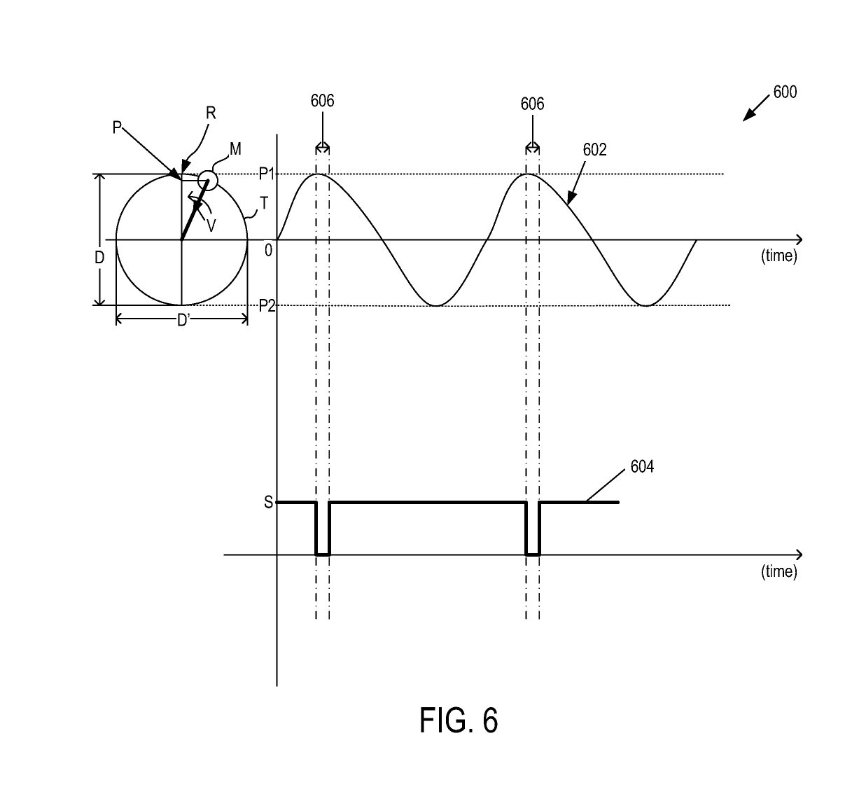

The output and eccentric mass control signals 516 and 518 may be used to selectively control the direction and magnitude of the positive force-feedback applied to a control device, for example, the handle 409 (FIG. 4). A time graph 600 illustrating the concept of creating a positive-force feedback using a rotating eccentric mass by the coordinated control of a MR fluid-based damper is shown in FIG. 6. The example using a rotating mass is illustrative for the sake of discussion but is should be appreciated that the control concept described relative thereto is applicable to any condition where a vibration is present in the handle 409, whether the vibration is natural or artificially created, and is not limited to use of a buzzer. The graph 600 illustrates time-aligned signals for the sake of discussion. A first curve 602 represents a position, P, of the projection of the position of the rotating mass, M, onto a diameter, D, of its circular trajectory, T, relative to reference or zero position, R. Accordingly, the projection of the mass onto the diameter D will appear as a sinusoidal wave as it rotates around an axis. The curve will cross zero each time the mass it at diametrically opposite positions and lies onto a reference diameter, D′, which is predetermined and lies at 90 degrees relative to the reference diameter, D, and occupy positions P1 and P2 when it occupies diametrically opposite positions disposed on a the diameter D. As shown, P1 can be positive and P2 can be negative, even though those designations are solely for illustration. The first curve 602 may be created if the positional information from the encoder 424 is plotted over time. As can be appreciated, when the mass M is rotating, the vibration it creates will have a vector, V, tending to pull the mass into a continuously variable direction. Thus, when providing a force in a particular direction is desired, certain segments of the trajectory of the mass M may be selected for amplification, while the remaining portions be dampened.

In the graph 600, a second curve 604 illustrates a control signal provided to a variable damper, for example, a MR fluid-based damper that lies in a particular orientation, over time. One example of such damper is the device 412 (FIG. 4). In general, the stiffness of the variable damper is proportional to the intensity of the signal, S. Here, the damper is shown to receive a maximum signal, S, for the majority of the time except for certain force-feedback periods, 606, during which the rotating mass M is a particular position. When the control signal is maximum, the corresponding damper is stiff to avoid displacement of the control handle 409. During the periods 606, the signal S is reduced such that the damper is allowed to move and thus the handle is displaced in the desired direction. Although a square wave is shown for the signal S, other shapes may be used. For example, the transition between maximum and minimum or any other intensities for the signal S can have any desired shape including a linear relationship. The coordinated activation of the damper with respect to the position and orientation of the force vector V of the rotating mass M in this fashion will create a directional and pulsed positive-feedback force in a selected direction, while force applied in other directions will be muted.

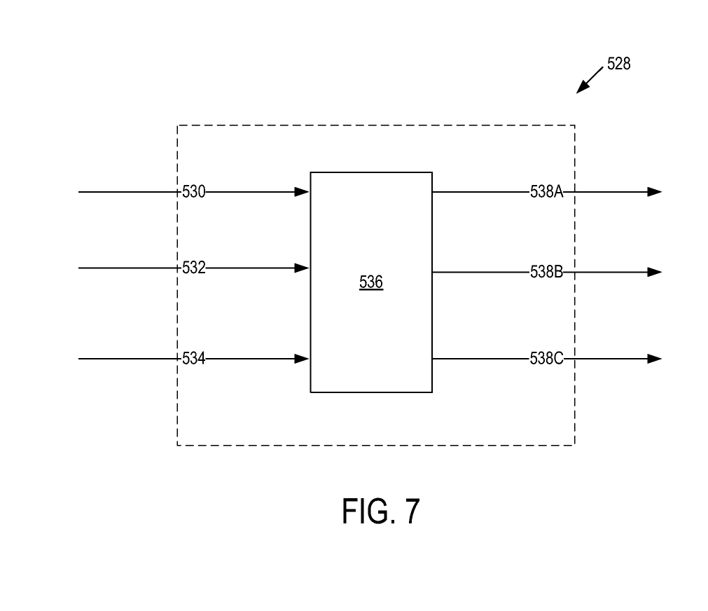

FIG. 7 is one embodiment for a block diagram of a force-feedback control 528 operating under this principle. The control 528 is disposed to receive information relative to the position and speed of a rotating mass associated with a manual control device, for example, the rotating mass assembly 418. Specifically, the control 528 may receive a rotating speed signal or a rotational position signal 530. In alternative embodiments, the control 528 may receive information relative to the natural vibration experienced at the operator cab or at the handle of a manual control device. The control 528 may also receive a desired direction of force application signal 532 relative to the manual control, as well as a position signal 534 indicative of the then present position of the manual control with respect to the desired direction of force application. This information is provided to a feedback force processor 536, which calculates the appropriate time intervals, for example, the periods 606 (FIG. 6), during which the stiffness of one or more variable dampers, for example, the power of magnets in MR fluid-based dampers or the valve setting in a variable hydraulic damper, either of which may be associated with the manual control, are adjusted to provide a positive force-feedback to the manual control, as previously described. In certain embodiments, for example, where a linear or one-dimensional vibration device is used as previously described, the position of a reciprocating slug need not be measured and can be determined based on the operation of the vibration device. Thus, control signals 538A, 538B and 538C may be provided to three variable damper devices acting along three dimensions to control the force feedback in any direction. Although three such signals are shown here, fewer or more than three may be used depending on the type of manual control and the degrees of freedom it is designed to provide. In this way, a control that has exceeded the possible force response of an actuator may be pushed into a position that will not cause an overshoot of the actuator when the capability of the system to respond to a command is restored, as previously discussed

### INDUSTRIAL APPLICABILITY

The present disclosure is applicable to a wide array of applications in which a directional pulse of force is desirable during operation. In the embodiments discussed, the variable stiffness and positive-force feedback is provided to a manual control device, such as a joystick handle, which is configured to control operation of work implements in a machine. The variable stiffness ensures that the capability of the system is not exceeded, while the positive force-feedback is used to bring the handle back into an acceptable position that corresponds to the force output capability of the system and avoids overshoots in the event system capability is restored.

It should be appreciated that the control of the application of the force from a natural or from an induced vibration, for example, one provided by a rotating mass, into a selected direction by coordinated control of a variable damper such as a MR fluid-based damper has wide applicability in other fields that a haptic force-feedback can be provided to a manual control. For example, although a control operating machine implements is disclosed, any other type of manual control used in any other type of land, air or sea machine may be used. Moreover, other devices such as game or remote-device controllers where it is desired to make physical or machine limitations directly known to the operator may make use of the systems and methods disclosed herein without departing from the spirit of the disclosure. Further, the directional application of pulsing force may have application on a much larger scale, such as hydraulic hammers, subterranean drilling apparatus, and the like.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A machine having an actuator operating to displace an implement of the machine based on a command provided by an operator, the command provided in the form of a displacement of a handle of a manual control device by the operator, the displacement occurring in an activation direction of the handle, the machine comprising:
a variable damper associated with the handle and being extendible or retractable upon motion of the handle, the variable damper configured to selectively alter a stiffness thereof in response to a control signal;
a displacement sensor associated with the variable damper and configured to provide a displacement signal indicative of a displacement of the handle in a direction associated with the variable damper; and
a controller associated with the manual control device, the displacement sensor, the variable damper, and the actuator, the controller disposed to:
determine a then present operating state of the actuator,
determine a command provided to the actuator based on the displacement signal, and
provide the control signal to stiffen the variable damper such that the displacement of the handle is limited to an additional displacement of the handle that corresponds to a difference between the then present operating state of the actuator and a maximum allowable operating state of the actuator.

2. The machine of claim 1, wherein the variable damper is a magnetorheological (MR) fluid-based damper having an electromagnet associated therewith, the control signal being provided to the electromagnet from the controller.

3. The machine of claim 1, further comprising one or more additional displacement directions of the handle, each additional displacement direction associated with a dedicated variable damper having a dedicated displacement sensor, wherein the controller is configured to provide additional control signals based on simultaneous motion of the handle in the one or more of the additional displacement directions.

4. The machine of claim 1, further comprising an axial or rotary vibratory device buzzer device associated with the handle.

5. The machine of claim 4, wherein the vibratory device is an eccentric weight rotating mass assembly, the eccentric-weight rotating mass assembly comprising:
a motor responsive to a command signal from the controller;
a mass connected to an output shaft of the motor and having a center of gravity that is offset relative to an axis of rotation of the output shaft of the motor,
an encoder configured to provide a rotational signal to the controller that is indicative of a rotational position of the mass relative to the handle;
wherein the controller is further configured to provide the command signal to the motor and the control signal to the variable damper based on the rotational signal and the displacement signal such that a directional impulse force feedback is provided in a predetermined direction when the command provided to the actuator is more than the difference between the then present operating state of the actuator and the maximum allowable operating state of the actuator.

6. The machine of claim 5, wherein the impulse force feedback is provided by reducing the stiffness of the variable damper periodically, as determined by the rotational signal, when the mass has a velocity vector lying in or close to the predetermined direction.

7. The machine of claim 5, wherein the predetermined direction is opposite the activation direction.

8. The machine of claim 5, wherein the command signal to the motor is configured to cause the motor to rotate the mass at a constant angular velocity, and wherein the control signal is configured to provide a maximum stiffness to the variable damper at all times except during a period during which the rotational signal indicates that the mass is passing through a predetermined angular range of motion.

9. The machine of claim 1, wherein the controller is further disposed to:
determine a rotational signal indicative of at least a frequency of a natural vibration that is present at the handle of the manual control device, the determination of the rotational signal being based on the displacement signal, and
provide the control signal to the variable damper based on the rotational signal and the displacement signal such that a directional impulse force feedback is provided in a predetermined direction when the command provided to the actuator is more than the difference between the then present operating state of the actuator and the maximum allowable operating state of the actuator.

10. A method for providing haptic information to an operator of a manual control device for a system, the manual control device including a handle adapted for use by the operator to issue commands, the commands provided in the form of a displacement of the handle in an activation direction, the extent of displacement being indicative of a magnitude of each command, the method comprising:
selectively altering a stiffness of a variable damper associated with the handle;
determining a then present command based on the displacement of the handle;
determining a maximum possible command that is allowable based on a capability of the system; and
limiting the displacement of the handle to an additional displacement of the handle that corresponds to a difference between the then present command and the maximum possible command by stiffening the variable damper when the then present command approaches the maximum possible command.

11. The method of claim 10, wherein selectively altering the stiffness of the variable damper includes increasing the stiffness as the then present command approaches the maximum possible command.

12. The method of claim 10, wherein limiting the displacement of the handle occurs in more than one direction simultaneously.

13. The method of claim 10, further comprising inducing a vibration to the handle or to the variable damper by displacing a mass, the vibration being applied in an axial or rotary fashion.

14. The method of claim 13, wherein the vibration is applied by use of an eccentric-weight rotating mass assembly associated with the handle, the eccentric-weight rotating mass assembly comprising:
a motor responsive to a command signal from the controller;
a mass connected to an output shaft of the motor and having a center of gravity that is offset relative to an axis of rotation of the output shaft of the motor,
an encoder configured to provide a rotational signal to the controller that is indicative of a rotational position of the mass relative to the handle;
wherein limiting the displacement of the handle is further based on the rotational signal;
providing a directional impulse force feedback in a predetermined direction when the command provided to the system exceeds the difference between the then present command and the maximum possible command.

15. The method of claim 13, further comprising reducing the stiffness of the variable damper periodically when the mass has a velocity vector lying in or close to the predetermined direction.

16. The method of claim 15, wherein the predetermined direction is opposite the activation direction.

17. The method of claim 10, further comprising determining a rotational signal of a natural vibration of the handle based on the displacement of the handle, and providing a directional impulse force feedback based on the rotational signal and the displacement of the handle when the command provided to the actuator exceeds the difference between the then present operating state of the actuator and the maximum allowable operating state of the actuator.

18. A positive-force generating device mounted via at least one variable damper to a machine, the variable damper configured to selectively alter a stiffness thereof in response to a control signal, the device being moveable in a direction of application of an impulse force by compression or extension of the variable damper, comprising:
a displacement sensor associated with the variable damper and configured to provide a displacement signal indicative of a displacement of the device; and
a controller associated with the variable damper, the device and the displacement sensor, the controller disposed to selectively provide the control signal to alter the stiffness of the variable damper;
a motor responsive to a command signal from the controller;
a mass connected to an output shaft of the motor and having a center of gravity that is offset relative to an axis of rotation of the output shaft of the motor;
an encoder configured to provide a rotational signal to the controller that is indicative of a rotational position of the mass relative to the device;
wherein the controller is configured to provide the command signal to the motor and the control signal to the variable damper based on the rotational signal and the displacement signal such that the impulse force is selectively provided along a predetermined direction.

19. The device of claim 18, wherein the impulse force feedback is provided by reducing the stiffness of the variable damper periodically, as determined by the rotational signal, when the mass has a velocity vector lying in or close to the predetermined direction.

20. The device of claim 18, wherein the command signal to the motor is configured to cause the motor to rotate the mass at a constant angular velocity, and wherein the control signal is configured to provide an increased stiffness to the variable damper at all times except during a period during which the rotational signal indicates that the mass is passing through a predetermined angular range of motion.
